(19) United States
(12) Patent Application Publication
(10) Pub. No.: US 2020/0046455 A1
(43) Pub. Date: Feb. 13, 2020

(54) Disposable Dental Tool

(71) Applicant: Henan Jian Li Da Medical Instrument Co., Ltd., Zhengzhou (CN)

(72) Inventors: Jian Zhang, Zhengzhou (CN); Xiaoping LI, Zhengzhou (CN)

(21) Appl. No.: 16/058,995

(22) Filed: Aug. 8, 2018

(51) Int. Cl. A61C 1/12

(52) U.S. Cl. CPC A61C 1/12; A61C 1/16

(57) ABSTRACT

A disposable dental tool includes a disposable handpiece and a bit mount and dismount device. The disposable handpiece includes an elongated handle body, a drill head provided at one end of the handle body, and a through holding channel for holding a drill bit thereat. The bit mount and dismount device includes a handheld actuator having a thumb pusher surface and an opposed bit pusher surface, and a pusher bit protruded from the bit pusher surface. The thumb pusher surface of the handheld actuator is held to push the bit pusher surface thereof toward the drill head for mounting the drill bit at the disposable handpiece by pushing the drill bit through the through holding channel and for dismounting the drill bit at the disposable handpiece by pushing the drill bit out of the through holding channel via the pusher bit.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to dental tools, and more particularly to a disposable dental tool, wherein the drill bit is mounted to a disposable handpiece for dental drilling and is dismounted from the disposable handpiece for prevent the drill bit from being reused.

### Description of Related Arts

Dental drills are one of the common dental tools during dental procedures for reducing at least a portion of a tooth prior to performing work on the area of the patient's mouth on the teeth. For example, dental drills are used for removing decay and shaping tooth structure prior to work beneath the gum line or to the insertion of a filling or crown. Generally speaking, the dental drill comprises a handpiece, a drill head provided at one end of the handpiece, and a drill bit held at the drill head.

During dental procedure, the drill head must be inserted into the oral cavity of the patient, wherein at least a portion of the handpiece and the drill head will unavoidably touch the teeth, oral mucosa, and/or blood inside the oral cavity. In addition, when the dental drill incorporates with a fluid discharger for discharging fluid at the drill head toward the drill bit, fluid may be remained at or sucked back into the drill head during the dental procedure. In other work, the fluid will be contaminated once the drill head is used. When the dental drill is re-used, the contaminated dental drill and contaminated fluid will touch the next patient, resulting in contamination and disease transmission. In particular, disease, such as hepatitis and HIV, can be simply transmitted through blood, saliva, and mucosa.

In order to prevent the transmission of diseases via the dental drill, the dental drill must be completely disinfected. Accordingly, autoclaving is the most common sterilization process for sterling the dental drill and killing all microorganisms thereat. There is a guide for processing autoclaving that the operator must follow the procedure step by step in order to completely disinfect the dental drill. However, the autoclaving machine and the sterilizing cost is expansive, and the sterilizing time is relatively long.

### SUMMARY OF THE PRESENT INVENTION

The invention is advantageous in that it provides a disposable dental tool, wherein the drill bit is mounted to a disposable handpiece for dental drilling and is dismounted from the disposable handpiece for prevent the drill bit from being reused.

Another advantage of the invention is to a disposable dental tool, wherein the operator, such as the dentist, will not touch the used drill bit when it is dismounted from the disposable handpiece, so as to prevent any disease from transmitting to the operator during the dismounting operation of the drill bit.

Another advantage of the invention is to a disposable dental tool, wherein the dismounting operation of the drill bit is easy and simple by pushing the drill head at a receiving cavity of a bit mount and dismount device and pushing the drill bit out of the drill head by a pusher bit within the receiving cavity. In other words, the present invention provides a safe and convenient way to dismount the drill bit from the disposable handpiece.

Another advantage of the invention is to a disposable dental tool, wherein the used drill bit is removed from the disposable handpiece, such that the used drill bit and the used disposable handpiece can be easily, individually, and safely handled once the dental drill is used, so as to prevent the cross-infection problem to protect the patients.

Another advantage of the invention is to a disposable dental tool, wherein the disposable handpiece is made of recycling material, such as recycling plastic, so as to simplify the manufacturing process of the dental drill. In other words, the disposable handpiece is inexpensive, simple to manufacture and easy to use.

Another object of the present invention is to provide a disposable dental tool, wherein no expensive or complicated structure is required to employ in the present invention in order to achieve the above mentioned objects. Therefore, the present invention successfully provides an economic and efficient solution for providing a disposable arrangement and configuration for the dental drill in a convenient and sanitary manner.

Additional advantages and features of the invention will become apparent from the description which follows, and may be realized by means of the instrumentalities and combinations particular point out in the appended claims.

According to the present invention, the foregoing and other objects and advantages are attained by a disposable dental tool, comprising:

a disposable handpiece comprising an elongated handle body, a drill head provided at one end of the handle body, and a bit holder for holding a drill bit thereat, wherein the bit holder has a through holding channel extended from a rear side of the drill head to a front side thereof, such that the drill bit is held at the through holding channel and is protruded from the front side of the drill head; and

a bit mount and dismount device which comprises a handheld actuator having a thumb pusher surface and an opposed bit pusher surface, and a pusher bit protruded from the bit pusher surface, wherein the thumb pusher surface of the handheld actuator is held to push the bit pusher surface of the handheld actuator toward the drill head for mounting the drill bit at the disposable handpiece by pushing the drill bit through the through holding channel and for dismounting the drill bit at the disposable handpiece by pushing the drill bit out of the through holding channel via the pusher bit.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a disposable dental tool according to a preferred embodiment of the present invention.

FIG. 2 is a sectional view of a disposable handpiece of the disposable dental tool according to the above preferred embodiment of the present invention.

FIG. 3 is a sectional view of a bit mount and dismount device of the disposable dental tool according to the above preferred embodiment of the present invention.

FIG. 4 is a top view of the bit mount and dismount device of the disposable dental tool according to the above preferred embodiment of the present invention.

FIGS. 5A and 5B illustrate a mounting operation of the drill bit according to the above preferred embodiment of the present invention.

FIGS. 6A and 6B illustrate a mounting operation of the drill bit according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

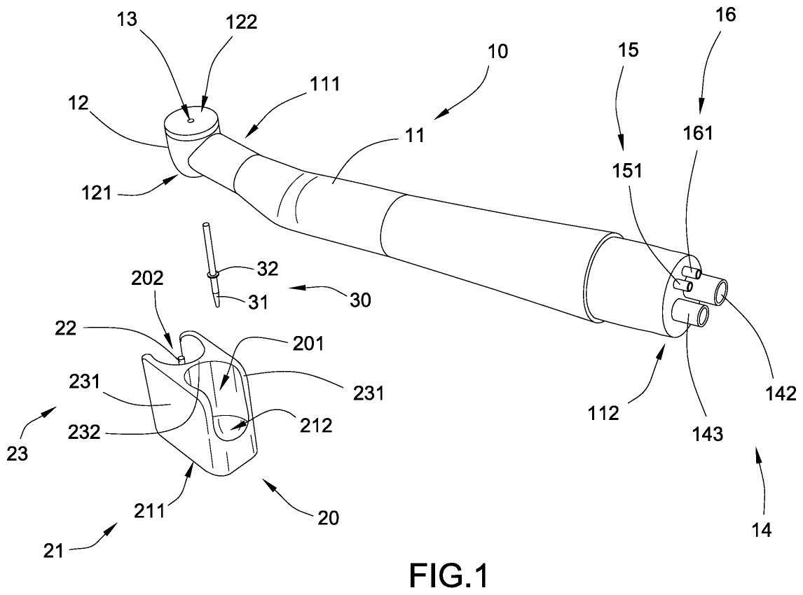

Referring to FIGS. 1 to 4, a disposable dental tool according to a preferred embodiment of the present invention is illustrated, wherein the disposable dental tool comprises a disposable handpiece 10, a drill bit 30, and a bit mount and dismount device 20 for mounting and dismounting the drill bit 30 at the disposable handpiece 10.

The disposable handpiece 10 comprises an elongated handle body 11, a drill head 12 provided at one end of the handle body 11, and a bit holder 13 for holding the drill bit 30 thereat. The handle body 11 is made of disposable material. Preferably, the handle body 11 is made of recycling material and is designed for one time use. The bit holder 12 is integrally extended from one end of the handle body 11. Accordingly, the handle body 11 has an angled neck portion 111 extended to integrate with the drill head 12. The bit holder 13 has a through holding channel 131 extended from a rear side 122 of the drill head 12 to a front side 121 thereof, such that the drill bit 30 is held at the through holding channel 131 and is protruded from the front side 121 of the drill head 12.

The bit mount and dismount device 20 comprises a handheld actuator 21 having a thumb pusher surface 211 and an opposed bit pusher surface 212, and a pusher bit 22 protruded from the bit pusher surface 212. Accordingly, the thumb pusher surface 211 of the handheld actuator 21 is held to push the bit pusher surface 212 of the handheld actuator 21 toward the drill head 12 for mounting the drill bit 30 at the disposable handpiece 10 by pushing the drill bit 30 through the through holding channel 131 and for dismounting the drill bit 30 at the disposable handpiece 10 by pushing the drill bit 30 out of the through holding channel 131 via the pusher bit 22.

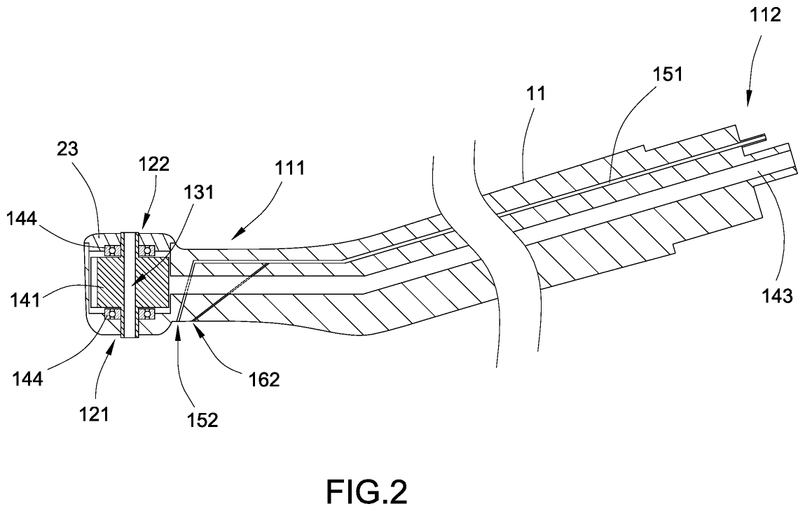

As shown in FIGS. 1 and 2, the disposable handpiece 10 is a high speed dental drill when the drill bit 30 is mounted thereto. According to the preferred embodiment, the disposable handpiece 10 further comprises a turbine arrangement 14 for rotatably driving the drill bit 30 in a high speed manner. The turbine arrangement 14 comprises a rotary turbine 141 rotatably supported within the drill head 12 at a position between the front and rear sides 121, 122 thereof. The rotary turbine 141 has a through slot coaxially aligned with the through holding channel 131, wherein when the drill bit 30 is held along the through holding channel 131, the drill bit 30 is engaged with the through slot of the rotary turbine 141. Therefore, when the rotary turbine 141 is rotated, the drill bit 30 is driven to rotate.

The turbine arrangement 14 further comprises a turbine air intake channel 142 and a turbine air exhaust channel 143 spacedly extended within the handle body 11 to the drill head 12 to drive the rotary turbine 141 to rotate. Accordingly, when a flow of turbine air is delivered to the turbine air intake channel 142, the rotary turbine 141 is pushed and driven to rotate by the turbine air 142. The turbine air will return to the turbine air exhaust channel 143 after the rotary turbine 141 is pushed. Preferably, a diameter of the turbine air intake channel 142 is larger than or equal to a diameter of the turbine air exhaust channel 143.

Accordingly, the rotary turbine 141 has a plurality of driving blades extended radially, wherein when the turbine air flows and hits the driving blades of the rotary turbine 141, the rotary turbine 141 is driven to rotate within the drill head 12. As a result, the drill bit 30 is driven to rotate correspondingly. The rotational speed of the drill bit 30 can be controlled by the speed of the turbine air.

Preferably, the turbine arrangement 14 further comprises two rotary bearings 144 spacedly supported within the drill head 12 to enhance the rotational movement of the drill bit 30. Accordingly, the rotary turbine 141 is coaxially aligned with the rotary bearings 144 and is located between the rotary bearings 144, wherein when the drill bit 30 is engaged with the rotary turbine 141, the drill bit 30 is also engaged with the rotary bearings 144 so as to allow the smooth rotational movement of the drill bit 30.

The disposable handpiece 10 further comprises a compression air arrangement 15 and a water delivery arrangement 16. The compression air arrangement 15 comprises a compression air channel 151 extended within the handle body 11 and an air outlet 152 provided at the handle body 11, wherein a flow of compression air is delivered along the compression air channel 151 and is exited at the air outlet 152 toward the drill bit 30. The water delivery arrangement 16 comprises a water channel 161 extended within the handle body 11 and a water outlet 162 provided at the handle body 11, wherein a flow of compression air is delivered along the water channel 161 and is exited at the water outlet 162 toward the drill bit 30. Accordingly, the air outlet 152 and the water outlet 162 are positioned adjacent to each other and are provided at the angled neck portion 111 of the handle body 11. For example, during the dental procedure for removing decay, the compression air can be ejected via the air outlet 152 to dry the working area of the patient and the water can be ejected via the water outlet 162 to cleanse the working area of the patient.

According the preferred embodiment, the handle body 11 further comprises an adapter end 112 opposed to the drill head 12 for detachably connecting a power source. The power source comprises a turbine air source, a compression air source, and a water source. The turbine air source can be the same or different from the compression air source. The turbine air intake channel 142, the turbine air exhaust channel 143, the compression air channel 151 and the water channel 161 are extended within the handle body 11 to the adapter end 112 thereof. Once the adapter end 112 of the handle body 11 is connected to the power source, the turbine air source provides the turbine air to the turbine air intake channel 142, the compression air source provides the compression air to the compression air channel 151, and the water source provides water to the water channel 161.

The drill bit 30 has a bit body 31 having a first end and an opposed second end, and a bit stopper 32 outwardly and radially extended from the bit body 31 between the first and second ends thereof. The second end of the bit body 31 is a sharp end.

According to the preferred embodiment, the handheld actuator 21 has a compact size adapted to be held by the user's hand in order to mount and dismount the drill bit 30 at the disposable handpiece 10. The pusher bit 22 is made of rigid material, such as metal, and is protruded from the bit pusher surface 212 of the handheld actuator 21. The pusher bit 22 is arranged to slidably insert into the through holding channel 131 to push the drill bit 30 out of the through holding channel 131.

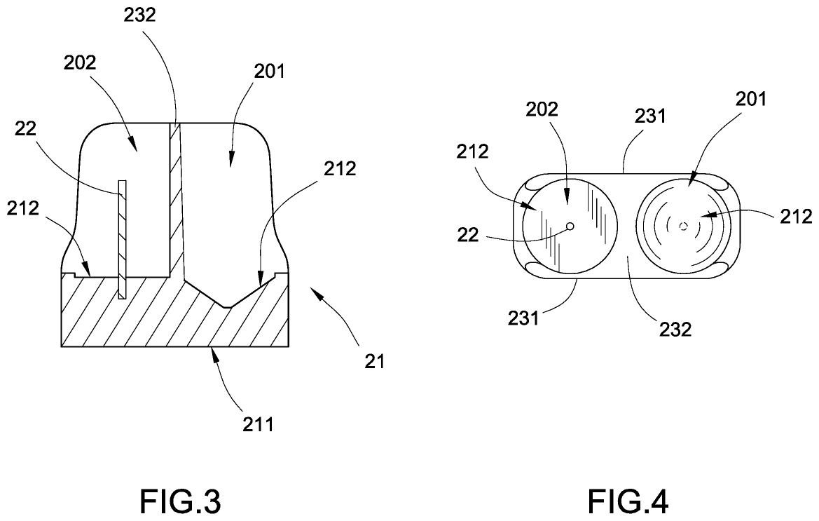

As shown in FIGS. 3 and 4, the handheld actuator 21 further comprises a surrounding wall arrangement 23 integrally extended from the bit pusher surface 212 to define a mounting cavity 201 and a dismounting cavity 202 slidably fitting the drill head 12 thereinto. Each of the mounting cavity 201 and the dismounting cavity 202 has a shape matching with a shape of the drill head 30, such that the drill head 30 can be fitted into each of the mounting cavity 201 and the dismounting cavity 202.

The surrounding wall arrangement 23 comprises two peripheral walls 231 parallely extended from the bit pusher surface 212 and a partition wall 232 integrally extended between the peripheral walls 231 to form the mounting cavity 201 and the dismounting cavity 202. Furthermore, each of the mounting cavity 201 and the dismounting cavity 202 has a side opening between edges of the peripheral walls 231. When the drill head 30 is disposed in one of the mounting cavity 201 and the dismounting cavity 202, the angled neck portion 111 of the handle body 11 is guided to slide at the corresponding side opening.

Accordingly, portions of the peripheral walls 231 and the partition wall 232 form a boundary wall of the mounting cavity 201 and portions of the peripheral walls 231 and the partition wall 232 form a boundary wall of the dismounting cavity 202. The boundary wall of the mounting cavity 201 contacts with the peripheral surface of the drill head 12 to guide the drill head 12 disposing in the mounting cavity 201 so as to ensure the drill bit 30 being alignedly inserted into the through holding channel 131. Likewise, the boundary wall of the dismounting cavity 202 contacts with the peripheral surface of the drill head 12 to guide the drill head 12 disposing in the dismounting cavity 202 so as to ensure the pusher bit 22 being alignedly inserted into the through holding channel 131 to push the drill bit 30 out of the through holding channel 131.

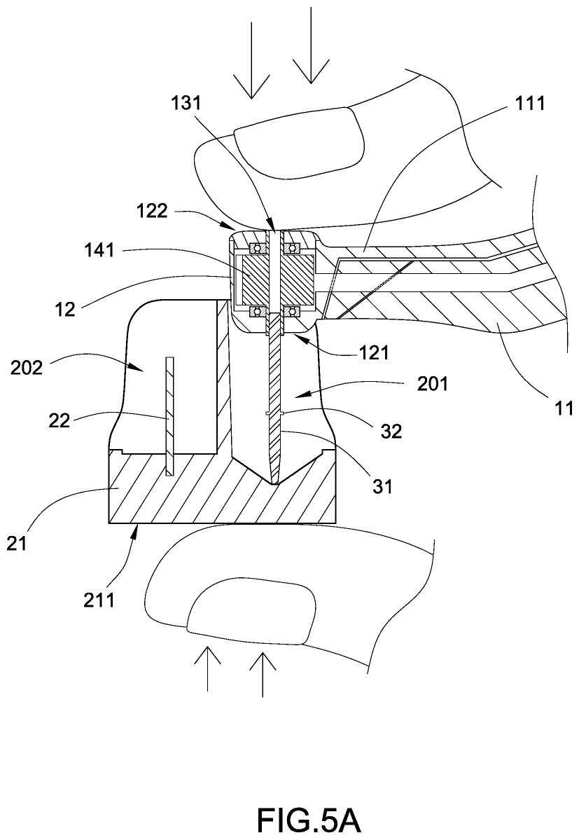

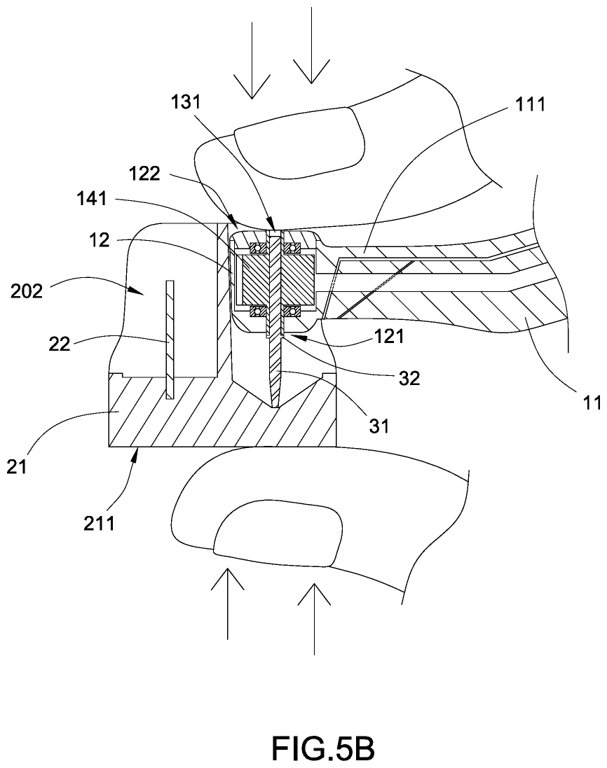

As shown in FIGS. 5A and 5B, the bottom wall of the mounting cavity 201, i.e. a portion of the bit pusher surface 212, has a conical shape that an apex is extended opposite to the opening of the mounting cavity 201. In other words, the opening of the mounting cavity 201 is embodied as a top opening that the apex of the mounting cavity 201 is extended downwardly. It is worth mentioning that the apex of the mounting cavity 201 is a flat surface to bias against the drill bit 30 when the drill bit 30 is pushed into the through holding channel 131. Therefore, when the first end of the drill bit 30 is inserted into the through holding channel 131 from the front side 121 of the drill head 12, the opposed second end of the drill bit 30 is biased against the bottom wall of the mounting cavity 201 at the apex thereof. Once the first end of the drill bit 30 is pushed along the through holding channel 131 to the rear side 122 of the drill head 12, a protruding portion of the drill bit 30 is protruded from the front side 121 of the drill head 12. The protruding portion of the drill bit 30 is the portion of the bit body 31 between the second end thereof and the bit stopper 32. In other words, the bit body 31 is pushed along the through holding channel 131 unit the bit stopper 32 is biased against the front side 121 of the drill head 122, so as to prevent the first end of the drill bit 30 being protruded from the rear side 122 of the drill head 12. Therefore, the first end of the bit body 31 of the drill bit 30 will not be protruded from the rear side 122 of the drill head 12.

Accordingly, the drill head 12 has a tapered shape that a size of the drill head 12 is gradually reduced from the rear side 122 to the front side 121. The mounting cavity 201 has a corresponding tapered shape that the diameter of the mounting cavity 201 is gradually reduced from the opening toward the bottom wall thereof. Having the corresponding tapered shape, the drill head 12 is ensured being slid into the mounting cavity 201 at a position that the front side 121 of the drill head 12 faces toward the bottom wall of the mounting cavity 201. In other words, the drill head 12 can only be disposed in the mounting cavity 201 at one direction that the front side of the drill head 12 faces toward the bottom wall of the mounting cavity 201. Due to the tapered shape of the mounting cavity 201, the drill head 12 cannot be disposed in the mounting cavity 201 at a position that the rear side 122 of the drill head 12 faces toward the bottom wall of the mounting cavity 201.

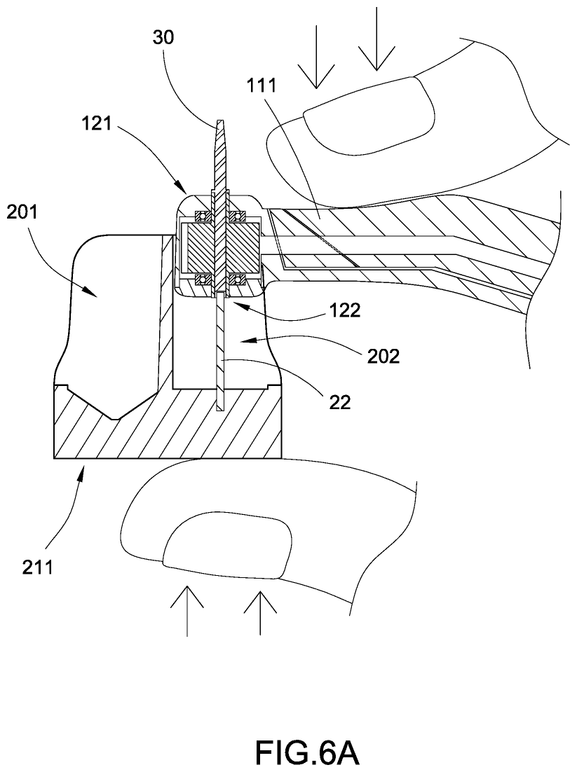

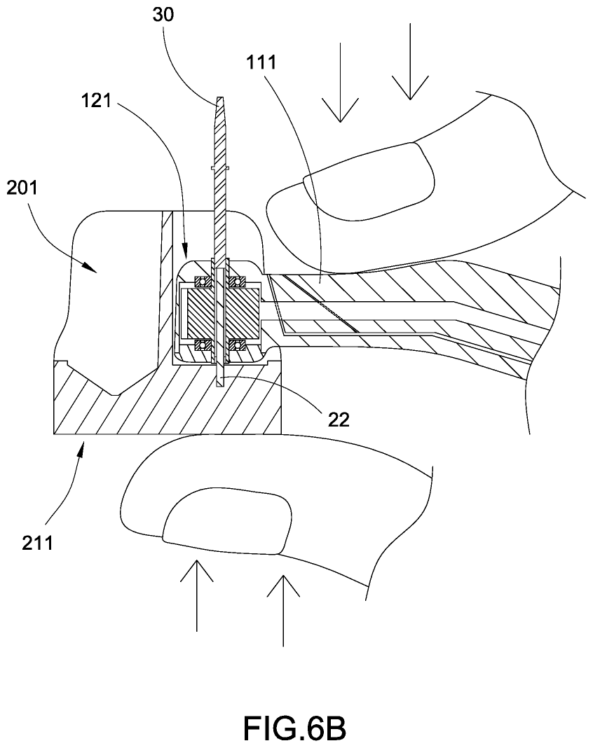

As shown in FIGS. 6A and 6B, the bottom wall of the dismounting cavity 202, is formed by another portion of the bit pusher surface 212. The bit pusher 22 is coaxially protruded from the bottom wall of the dismounting cavity 202. Accordingly, the bottom wall of the dismounting cavity 202 is a flat surface and the rear side 122 of the drill head 12 is also a flat surface. Therefore, when the drill head 12 is disposed in the dismounting cavity 202 at a position that the rear side of the drill head 12 faces toward the bottom wall of the dismounting cavity 202, the bit pusher 22 is alignedly inserted into the through holding channel 131 from the rear side 122 of the drill head 12. As a result, when the drill head 12 is entirely disposed in the dismounting cavity 202, the bottom wall of the dismounting cavity 202 contacts with the rear side of the drill head 12 for ensuring the drill bit 30 being pushed out of the drill head 12.

Accordingly, the dismounting cavity 202 has a tapered shape, wherein the diameter of the dismounting cavity 202 at the bottom wall thereof is slightly smaller or equal to the diameter of the rear side of the drill head 12. Therefore, when the drill head 12 is slidably disposed in the dismounting cavity 202 for pushing the drill bit 30 out of the through holding channel 131 via the pusher bit 22, the drill head 12 is held within the dismounting cavity 202 to ensure the pusher bit 22 being remained within the through holding channel 131. It is worth mentioning that a protruding length of the bit pusher 22, which is protruded from the bit pusher surface 212, is shorter than a length of the through holding channel 131. In other words, the bit pusher 22 will not protruded out of the front side 121 of the drill head 12 when the drill head 12 is entirely disposed in the dismounting cavity 202.

In order to mount the drill bit 30 at the disposable handpiece 10, the operator, such as a dental assistant, he or she is able to hold the drill bit 30 and slightly insert the first end of the drill bit 30 into the through holding channel 131 from the front side 121 of the drill head 12. Then, the operator is able to hold the handheld actuator 21 of the bit mount and dismount device 20 at a position that the thumb of the operator presses against the thumb pusher surface 211 of the handheld actuator 21. Another hand of the operator is able to hold the disposable handpiece 10 via the handle body 11 to dispose the drill head 12 with the drill bit 30 in the mounting cavity 201. The operator is able to push the handheld actuator 21 at the thumb pusher surface 211 thereof to push the drill head 12 in the mounting cavity 201. It is worth mentioning that the operator is also able to press the rear side 122 of the drill head 12 to push the drill head 12 in the mounting cavity 201. When the drill head 12 being pushed in the mounting cavity 201, the second end of the drill bit 30 is biased against the bottom wall of the mounting cavity 201 at the apex thereof. Therefore, the drill bit 30 is pushed by the bottom wall of the mounting cavity 201 and is driven to slide in the through holding channel 131. It is worth mentioning that the angled neck portion 111 of the handle body 11 is guided to slide at the side opening of the mounting cavity 201. The bit body 31 is pushed along the through holding channel 131 unit the bit stopper 32 is biased against the front side 121 of the drill head 122. Then, the drill head 12 cannot be further moved into the mounting cavity 201, wherein the drill bit 30 is retained within the through holding channel 131 and the first end of the drill bit 30 will not be protruded out from the rear side 122 of the drill head 12. It is worth mentioning that a clearance is formed within the through holding channel 131 between the first end of the drill bit 30 and the rear side 122 of the drill head 12 when the drill bit 30 is inserted.

In order to dismount the drill bit 30 from the disposable handpiece 10, the operator is able to hold the handheld actuator 21 of the bit mount and dismount device 20 at a position that the thumb of the operator presses against the thumb pusher surface 211 of the handheld actuator 21. Another hand of the operator is able to hold the disposable handpiece 10 via the handle body 11 to dispose the drill head 12 with the drill bit 30 in the dismounting cavity 202. Accordingly, the rear side 122 of the drill head 12 faces toward the bottom wall of the dismounting cavity 202. The operator is able to push the handheld actuator 21 at the thumb pusher surface 211 thereof to push the drill head 12 in the dismounting cavity 202. It is worth mentioning that the operator is also able to press the angled neck portion 111 of the handle body 11 to push the drill head 12 in the dismounting cavity 202. Preferably, the free end of the bit pusher 22 is located at the clearance of the through holding channel 131. When the drill head 12 being pushed in the dismounting cavity 202, the pusher bit 22 is alignedly inserted into the through holding channel 131 to push the drill bit 30 out of the through holding channel 131. It is worth mentioning that the angled neck portion 111 of the handle body 11 is guided to slide at the side opening of the dismounting cavity 202 until the angled neck portion 111 of the handle body 11 is blocked by a bottom edge of the side opening of the dismounting cavity 202. At the same time, the rear side of the drill head 12 is biased against the bottom wall of the dismounting cavity 202. Then, the drill head 12 cannot be further moved into the dismounting cavity 201, the drill bit 30 is pushed out of the drill head 12 and the drill head 12 is retained in the dismounting cavity 202 to keep the bit pusher 22 along the through holding channel 131. It is worth mentioning that when the rear side of the drill head 12 is biased against the bottom wall of the dismounting cavity 202, only the first end of the drill bit 30 is held at the through holding channel 131, such that the operator can easily dismount the drill bit 30 from the drill head 12 so as to prevent the drill bit 30 being accidentally popped out of the through holding channel 131. The used drill bit 30 being detached from the disposable handpiece 10 can be saved in a disposal container.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A disposable dental tool, comprising:
a disposable handpiece comprising an elongated handle body, a drill head provided at one end of said handle body, and a bit holder for holding a drill bit thereat, wherein said bit holder has a through holding channel extended from a rear side of said drill head to a front side thereof, such that the drill bit is held at said through holding channel and is protruded from said front side of said drill head; and
a bit mount and dismount device which comprises a handheld actuator having a thumb pusher surface and an opposed bit pusher surface, and a pusher bit protruded from said bit pusher surface, wherein said thumb pusher surface of said handheld actuator is held to push said bit pusher surface of said handheld actuator toward said drill head for mounting the drill bit at said disposable handpiece by pushing the drill bit through said through holding channel and for dismounting the drill bit at said disposable handpiece by pushing the drill bit out of said through holding channel via said pusher bit.

2. The disposable dental tool, as recited in claim 1, wherein said handheld actuator further comprises a surrounding wall arrangement integrally extended from said bit pusher surface to define a mounting cavity and a dismounting cavity slidably fitting said drill head thereinto, wherein each of said mounting cavity and said dismounting cavity has a shape matching with a shape of said drill head.

3. The disposable dental tool, as recited in claim 2, wherein said bit pusher surface forms a bottom wall of said dismounting cavity that said pusher bit is coaxially extended from said bit pusher surface within said dismounting cavity for pushing the drill bit out of said bit holder when said bit head is slidably disposed in said dismounting cavity.

4. The disposable dental tool, as recited in claim 2, wherein said bit pusher surface forms a bottom wall of said mounting cavity for pushing the drill bit to said bit holder when said bit head is slidably disposed in said mounting cavity at a position that said front side of said drill head faces toward said bottom wall of said mounting cavity.

5. The disposable dental tool, as recited in claim 3, wherein said bit pusher surface forms a bottom wall of said mounting cavity for pushing the drill bit to said bit holder when said bit head is slidably disposed in said mounting cavity at a position that said front side of said drill head faces toward said bottom wall of said mounting cavity.

6. The disposable dental tool, as recited in claim 4, wherein said bottom wall of said mounting cavity has a conical shape that an apex is extended opposite to an opening of said mounting cavity.

7. The disposable dental tool, as recited in claim 5, wherein said bottom wall of said mounting cavity has a conical shape that an apex is extended opposite to an opening of said mounting cavity.

8. The disposable dental tool, as recited in claim 5, wherein said bottom wall of said dismounting cavity is a flat surface to contact with said rear side of said drill head for ensuring the drill bit being pushed out of said drill head.

9. The disposable dental tool, as recited in claim 7, wherein said bottom wall of said dismounting cavity is a flat surface to contact with said rear side of said drill head for ensuring the drill bit being pushed out of said drill head.

10. The disposable dental tool, as recited in claim 2, wherein said surrounding wall arrangement comprises two peripheral walls parallely extended from said bit pusher surface and a partition wall integrally extended between said peripheral walls to form said mounting cavity and said dismounting cavity that each of said mounting cavity and said dismounting cavity has a side opening between edges of said peripheral walls.

11. The disposable dental tool, as recited in claim 9, wherein said surrounding wall arrangement comprises two peripheral walls parallely extended from said bit pusher surface and a partition wall integrally extended between said peripheral walls to form said mounting cavity and said dismounting cavity that each of said mounting cavity and said dismounting cavity has a side opening between edges of said peripheral walls.

12. The disposable dental tool, as recited in claim 10, wherein portions of said peripheral walls and said partition wall form a boundary wall of said mounting cavity that contacts with a peripheral surface of said drill head to guide said drill head disposing in said mounting cavity so as to ensure the drill bit being alignedly inserted into said through holding channel.

13. The disposable dental tool, as recited in claim 11, wherein portions of said peripheral walls and said partition wall form a boundary wall of said mounting cavity that contacts with a peripheral surface of said drill head to guide said drill head disposing in said mounting cavity so as to ensure the drill bit being alignedly inserted into said through holding channel.

14. The disposable dental tool, as recited in claim 2, wherein said drill head has a tapered shape that a size of said drill head is gradually reduced from said rear side to said front side, wherein said mounting cavity has a corresponding tapered shape to ensure said drill head being slid into said mounting cavity at a position that said front side of said drill head faces toward said bottom wall of said mounting cavity.

15. The disposable dental tool, as recited in claim 11, wherein said drill head has a tapered shape that a size of said drill head is gradually reduced from said rear side to said front side, wherein said mounting cavity has a corresponding tapered shape to ensure said drill head being slid into said mounting cavity at a position that said front side of said drill head faces toward said bottom wall of said mounting cavity.

16. The disposable dental tool, as recited in claim 14, wherein said dismounting cavity has a tapered shape, such that when said drill head is slidably disposed in said dismounting cavity for pushing the drill bit out of said through holding channel via said pusher bit, said drill head is held within said dismounting cavity to ensure said pusher bit being remained within said through holding channel.

17. The disposable dental tool, as recited in claim 15, wherein said dismounting cavity has a tapered shape, such that when said drill head is slidably disposed in said dismounting cavity for pushing the drill bit out of said through holding channel via said pusher bit, said drill head is held within said dismounting cavity to ensure said pusher bit being remained within said through holding channel.

18. The disposable dental tool, as recited in claim 1, wherein a protruding length of said bit pusher, which is protruded from said bit pusher surface, is shorter than a length of said through holding channel.

19. The disposable dental tool, as recited in claim 9, wherein a protruding length of said bit pusher, which is protruded from said bit pusher surface, is shorter than a length of said through holding channel.

20. The disposable dental tool, as recited in claim 1, wherein said thumb pusher surface of said handheld actuator is a flat surface.

21. The disposable dental tool, as recited in claim 19, wherein said thumb pusher surface of said handheld actuator is a flat surface.
